(19) United States
(12) Patent Application Publication
(10) Pub. No.: US 2020/0336324 A1
(43) Pub. Date: Oct. 22, 2020

(54) NETWORK SYSTEM

(71) Applicant: SHARP KABUSHIKI KAISHA, Osaka (JP)

(72) Inventor: TAKAYUKI NAGAMATSU, Osaka (JP)

(21) Appl. No.: 16/806,330

(22) Filed: Mar. 2, 2020

(30) Foreign Application Priority Data
Apr. 16, 2019 (JP) 2019-077595

(51) Int. Cl. H04L 12/28; G10L 15/22

(52) U.S. Cl. CPC H04L 12/282; H04L 12/2829; G10L 2015/223; G10L 15/22; H04L 12/2807

(57) ABSTRACT

A network system is provided that includes a communication terminal including a microphone, a plurality of electronic devices, and a server. The server is configured to transmit a prescribed operation command collectively to the plurality of electronic devices linked to the communication terminal, based on a prescribed voice message from the communication terminal.

### CROSS-REFERENCE TO RELATED APPLICATIONS

This application claims the benefit of priority to Japanese Patent Application Number 2019-077595 filed on Apr. 16, 2019. The entire contents of the above-identified application are hereby incorporated by reference.

### BACKGROUND

The disclosure relates to technology for controlling household electric appliances and the like through a network.

### TECHNICAL FIELD

In related art, technologies for receiving provision of various services through a network are known. For example, JP 2017-34525 A discloses a communication terminal, a program, a network system, and a server. According to JP 2017-34525 A, a communication terminal is provided including a display, a communication interface configured to communicate with a server, and a processor configured to acquire, from the server through the communication interface, information relating to at least one electronic device belonging to a group, and cause the information relating to the at least one electronic device belonging to the group being displayed in order on the display.

### SUMMARY

An object of the disclosure is to provide a network system including a user interface that is easier to use than in the related art.

According to an aspect of the disclosure, a network system is provided that includes a communication terminal including a microphone, a plurality of electronic devices, and a server. The server is configured to transmit a prescribed operation command collectively to a plurality of electronic devices linked to a communication terminal, based on a prescribed voice message from the communication terminal.

As described above, according to the disclosure, a network system including a user interface that is easier to use than in the related art is provided.

### BRIEF DESCRIPTION OF DRAWINGS

The disclosure will be described with reference to the accompanying drawings, wherein like numbers reference like elements.

FIG. 1 is an image diagram illustrating an overall configuration of a network system 1 according to a first embodiment.

FIG. 2 is an image diagram illustrating an example of an operation screen of a communication terminal 300 according to the first embodiment.

FIG. 3 is a block diagram illustrating a configuration of a server 100 according to the first embodiment.

FIG. 4 is an image diagram illustrating user information data 121 according to the first embodiment.

FIG. 5 is an image diagram illustrating device information data 122 according to the first embodiment.

FIG. 6 is an image diagram illustrating trigger data 123 according to the first embodiment.

FIG. 7 is an image diagram illustrating collective operation command data 124 according to the first embodiment.

FIG. 8 is a flowchart illustrating information processing of the server 100 according to the first embodiment.

FIG. 9 is a block diagram illustrating a configuration of an electronic device 200 according to the first embodiment.

FIG. 10 is a block diagram illustrating a configuration of the communication terminal 300 according to the first embodiment.

FIG. 11 is an image diagram illustrating an example of a time-line screen of the communication terminal 300 according to the first embodiment.

FIG. 12 is an image diagram illustrating an example of a normal confirmation screen of the communication terminal 300 according to the first embodiment.

FIG. 13 is an image diagram illustrating an example of a collective confirmation screen of the communication terminal 300 according to the first embodiment.

FIG. 14 is an image diagram illustrating an example of a collective operation registration screen of the communication terminal 300 according to the first embodiment.

FIG. 15 is an image diagram illustrating an example of an operation screen of the communication terminal 300 including a locking mechanism according to the first embodiment.

FIG. 16 is an image diagram illustrating an example of a second time-line screen of the communication terminal 300 according to the first embodiment.

FIG. 17 is an image diagram illustrating an example of a collective operation registration screen of the communication terminal 300 according to a second embodiment.

FIG. 18 is a flowchart illustrating information processing of the server 100 according to a third embodiment.

### DESCRIPTION OF EMBODIMENTS

Embodiments of the disclosure will be described below with reference to the drawings. In the following descriptions, identical components are given identical signs. Respective names and functions of the components are also identical. Thus, detailed descriptions will not be repeated for the components.

### First Embodiment

### Overall Configuration of Network System 1

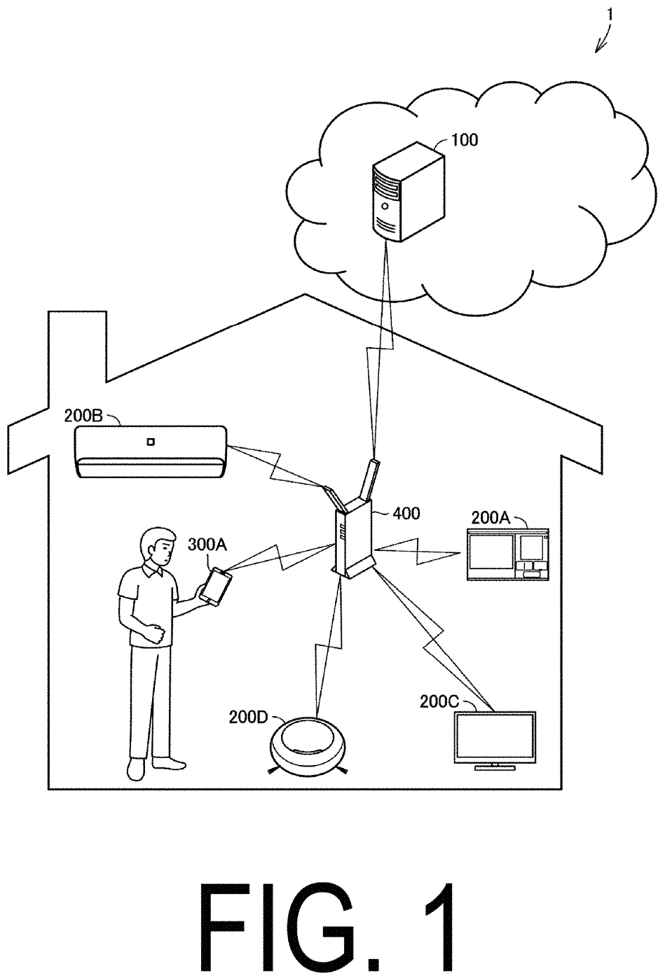

First, an overall configuration of a network system 1 according to a present embodiment will be described with reference to FIG. 1. The network system 1 according to the present embodiment mainly includes a server 100, an electronic device, such as a microwave oven 200A, an air conditioner 200B, a TV 200C, or a vacuum cleaner 200D, and a communication terminal such as a smart phone 300A.

Note that the electronic device is not limited to the microwave oven 200A, the air conditioner 200B, the TV 200C, the vacuum cleaner 200D, and the like, but also may be a household electric appliance such as a refrigerator, a washing machine, an air purifier, a humidifier, a dehumidifier, an automatic cooking pan, a rice cooker, and lighting, a personal computer, a hard disk recorder, a projector, a music player, a gaming device, audio visual (AV) device such as a speaker, home energy management system equipment such as a photo voltaic system, a storage cell system, and a hot water supply system, household equipment such as integrated lighting, an intercom, an electric lock, a water heater, a warm water washing toilet seat controller, or the like. Hereinafter, these electronic devices are collectively referred to as an electronic device 200.

Further, the communication terminal is not limited to the smart phone 300A, and may be a personal computer, a tablet, a gaming device, a speaker, a wearable terminal, or the like. Hereinafter, these communication terminals are collectively referred to as a communication terminal 300.

### Overview of Operations of Network System 1

Next, an overview of operations of the network system 1 according to the present embodiment will be described with reference to FIG. 1. With respect to the network system 1 according to the present embodiment, a plurality of cloud servers 100 provide various services. For example, a user can install an application for control of household electric appliances in the communication terminal 300, and can use the communication terminal 300 to remotely control the various electronic devices 200, and acquire operational information and environmental information about the electronic devices 200.

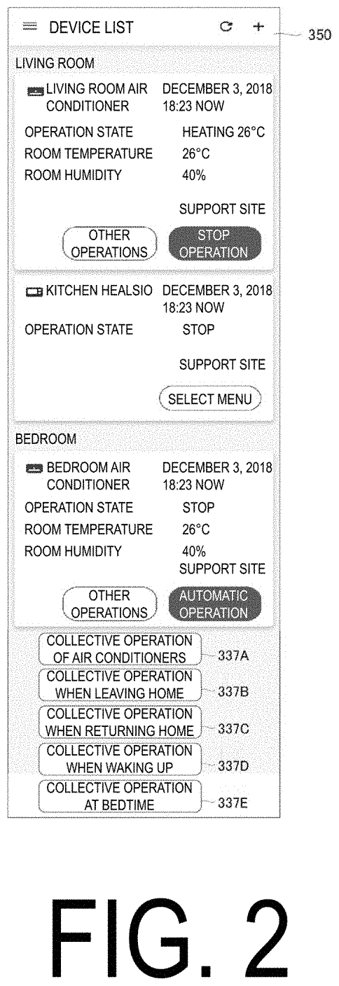

Then, in the present embodiment in particular, the user can use the communication terminal 300 to input an operation command collectively to the plurality of electronic devices 200 that have been set in advance. For example, as illustrated in FIG. 2, a plurality of air conditioners cease an air-conditioning operation when the user inputs a “collectively stop all air conditioners” command into the communication terminal 300, an operation command relating to when the user is out of the house is transmitted to the plurality of electronic devices 200 when the user inputs a “leaving home collective operation” command into the communication terminal 300, an operation command relating to when the user returns home is transmitted to the plurality of electronic devices 200 when the user inputs a “returning home collective operation” command into the communication terminal 300, an operation command relating to when the user wakes up is transmitted to the plurality of electronic devices 200 when the user inputs a “wake up collective operation” into the communication terminal 300, and an operation command relating to when the user goes to bed is transmitted to the plurality of electronic devices 200 when the user inputs a “bedtime collective operation” command into the communication terminal 300.

Note that, as to be described below, the input of the collective operation command is not limited to an input on an operation unit, and may be an input of a voice message to a microphone, may be triggered by a position of the user acquired using a position acquisition function, or may be triggered by locking or unlocking of a locking mechanism. Note that the locking mechanism refers to a locking/unlocking mechanism configured to lock or unlock using a door key or the like, and the locking/unlocking mechanism is referred to as a locking mechanism for the purpose of the description below.

In this way, in the network system 1 according to the present embodiment, the user can operate the plurality of electronic devices 200 in accordance with a given situation, through a simple operation. Hereinafter, a specific configuration of the network system 1 realizing such functions will be described in detail.

### Configuration of Server 100

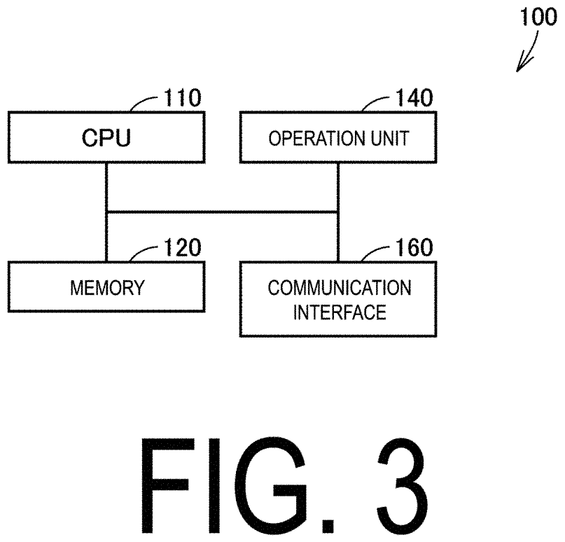

First, an example of the configuration of the server 100 configuring the network system 1 according to the present embodiment will be described. With reference to FIG. 3, the server 100 includes a central processing unit (CPU) 110, a memory 120, an operation unit 140, and a communication interface 160, as main constituent elements.

The CPU 110 controls each of units of the server 100 by executing programs stored in the memory 120. For example, the CPU 110 executes the programs stored in the memory 120 and performs various processing described below by referring to various data.

The memory 120 is realized by various types of random access memory (RAM), various types of read only memory (ROM), and the like, and may be configured to be embedded in the server 100, may be detachably connected to various interfaces of the server 100, or may be a recording medium of another device accessible from the server 100. The memory 120 stores the programs executed by the CPU 110, data generated by execution of the programs by the CPU 110, input data, databases utilized for other services according to the present embodiment, and the like.

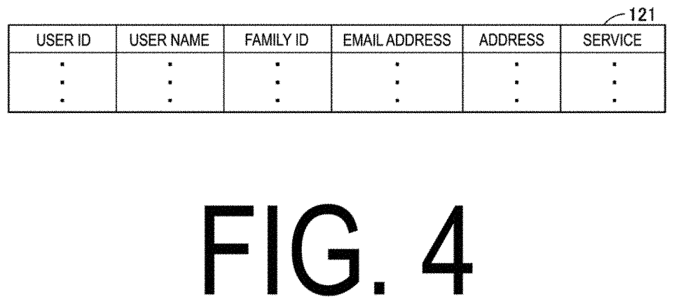

For example, the memory 120 stores user information data 121, as illustrated in FIG. 4. The user information data 121 stores, for each user, a user ID, a username, a family ID, an email address, an address, a password, identification information for various services to which the user is subscribed, service content, and the like.

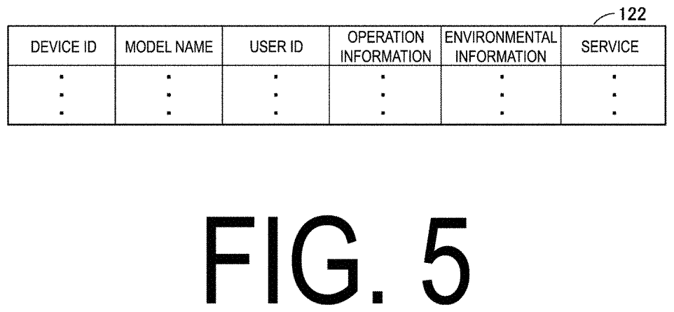

The memory 120 stores device information data 122, as illustrated in FIG. 5. The device information data 122 stores, for each electronic device, a device ID, a device type, an owner's user ID, running operation information, environmental information, and identification information and service content for various services for which the electronic device is registered.

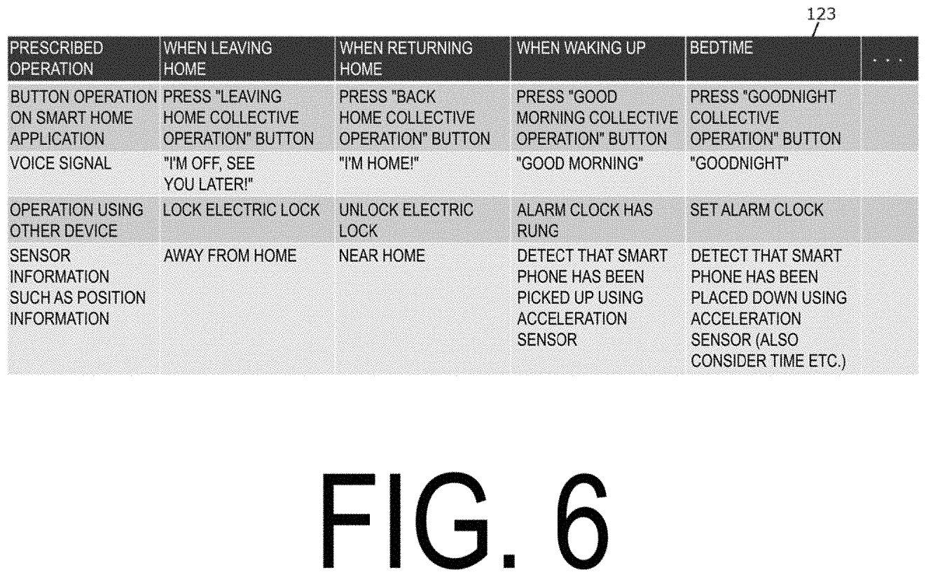

The memory 120 stores trigger data 123 as illustrated in FIG. 6. The trigger data 123 stores conditions under which the collective operation commands should be sent. For example, for each of prescribed timings such as “receiving prescribed operation,” “leaving home,” “returning home,” “waking up,” and “bedtime,”, the trigger data 123 stores a condition triggered by an input with respect to the operation unit of the communication terminal 300, a condition triggered by an input with respect to the microphone of the communication terminal 300, a condition triggered by an operation of the locking mechanism of the communication terminal 300, and a condition triggered by the current position of the user. In the present embodiment, the input of a command into an operation unit 340 of the communication terminal 300 in order to perform the collective operation, a voice message to a microphone 380 of the communication terminal 300, a positional relationship between the user's current position and the home address of the user, locking/unlocking operations by the locking mechanism, and the like are all considered to be the condition.

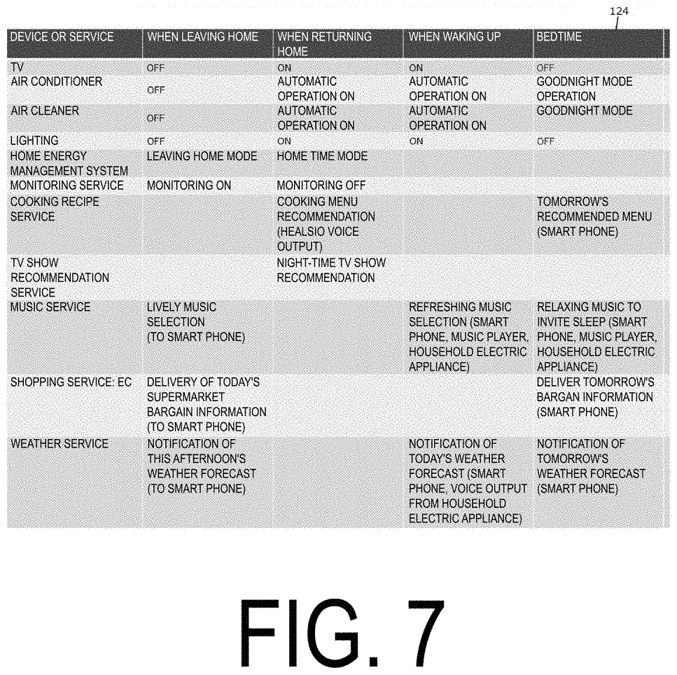

The memory 120 stores collective operation command data 124 as illustrated in FIG. 7. The collective operation command data 124 stores content of the collective operation commands. For example, the collective operation command data 124 stores operation commands that issue a command to each type of the electronic device 200, at each prescribed timing, such as “receiving prescribed operation,” “leaving home,” “returning home,” “waking up,” and “bedtime.”

Returning to FIG. 3, the operation unit 140 receives a command from a service administrator or the like, and inputs the command to the CPU 110.

The communication interface 160 transmits data from the CPU 110 to another device, such as the electronic device 200 or the communication terminal 300 via the Internet, a carrier network, a router, or the like. Conversely, the communication interface 160 receives data from the other device such as the electronic device 200, the communication terminal 300, and the like via the Internet, the carrier network, the router, or the like, and transfers the data to the CPU 110.

### Information Processing of Server 100

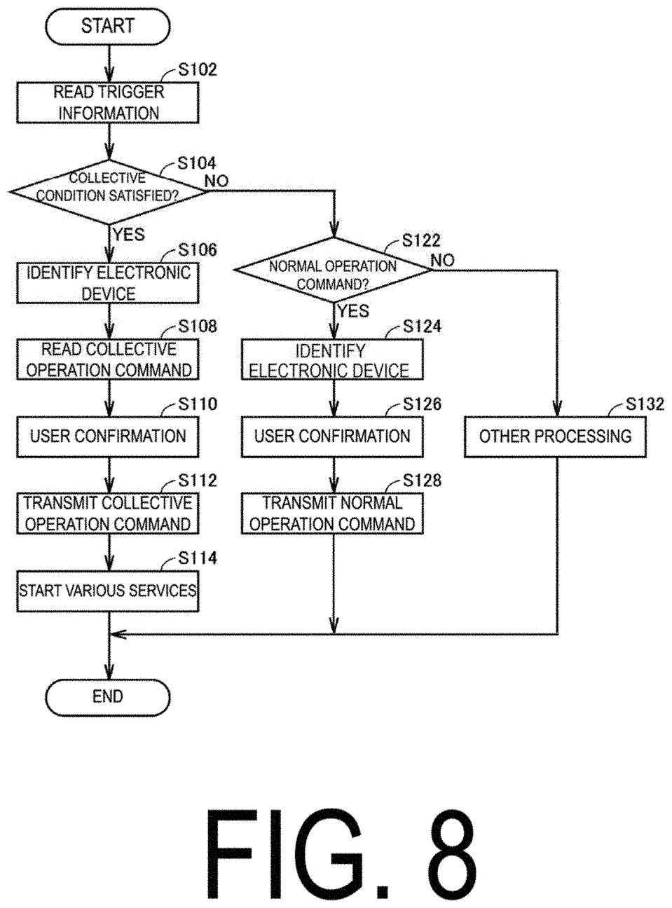

Next, information processing in the server 100 will be described with reference to FIG. 8. The CPU 110 of the server 100 according to the present embodiment executes the following processing upon receiving data from the communication terminal 300.

First, the CPU 110 reads out the trigger data 123 (step S102) and, on the basis of the data from the communication terminal 300, determines whether the condition to perform the collective operation is satisfied (step S104). Note that the CPU 110 determines whether the condition for the collective operation is satisfied on the basis of the command to the operation unit 340 of the communication terminal 300, or the voice command to the microphone 380 of the communication terminal 300, and the like. Further, on the basis of the current position of the communication terminal 300 and the address of the user's home, the CPU 110 determines whether the user is away from home, or has returned home. Alternatively, when the communication terminal 300 is a locking device, it may be determined whether the condition for the collective operation is satisfied on the basis of a locking operation or an unlocking operation of a front door.

If the condition to perform the collective operation is satisfied (YES at step S104), the CPU 110 refers to the device information data 122 and the user information data 121 to identify the electronic device 200 linked to the communication terminal 300 (step S106).

The CPU 110 refers to the collective operation command data 124 and reads out the operating command for each of the identified electronic devices 200 (step S108).

The CPU 110 transmits, via the communication interface 160, information to the user's communication terminal 300 in order to confirm whether the collective operation may be performed with respect to the electronic device 200 (step S110).

Once the user's confirmation is obtained, the CPU 110 transmits an operation command suitable for the current situation to the identified electronic device 200, via the communication interface 160 (step S112).

At this time, in the present embodiment, the CPU 110 may refer to the user information data 121 or the device information data 122 and may initiate services to which the user or the device is subscribed (step S114). For example, when the condition relating to being away from home or to bedtime is satisfied, the CPU 110 may transmit prescribed data to a security company service in order to start a security service from the security company, or, when the condition relating to being at home or waking up is satisfied, the CPU 110 may transmit prescribed data to the security company service in order to stop the security service of the security company.

On the other hand, if the condition to perform the collective operation is not satisfied (NO at step S104), the CPU 110 determines whether individual normal operations have been received (step S122). When the CPU 110 has received an individual normal operation (YES at step S122), the CPU 110 refers to the device information data 122 and the user information data 121 and identifies the electronic device 200 linked to the communication terminal 300 (step S124).

The CPU 110 transmits, via the communication interface 160, information to the user's communication terminal 300 to confirm whether the normal operation may be performed with respect to the electronic device 200 (step S126).

The CPU 110 transmits, via the communication interface 160, the individual normal operation command to the identified electronic device 200 (step S128).

If the CPU 110 has not received the individual normal operation (NO at step S122), then it performs other processing (step S132).

### Configuration of Electronic Device 200

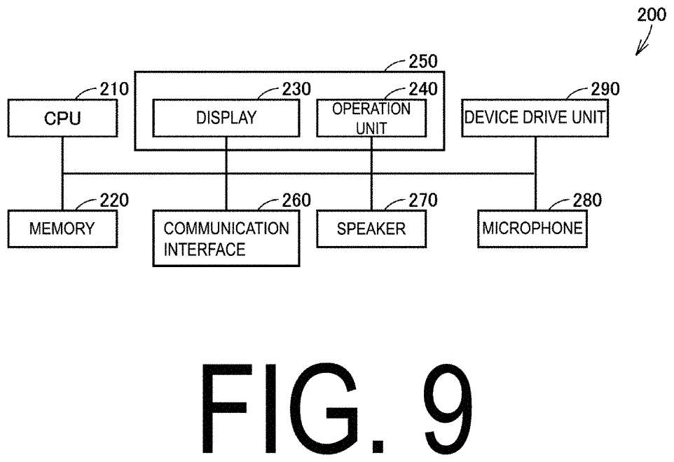

Next, an example of the configuration of the electronic device 200 configuring the network system 1 will be described with reference to FIG. 9. The electronic device 200 according to the present embodiment includes a CPU 210, a memory 220, a display 230, an operation unit 240, a communication interface 260, a speaker 270, a microphone 280, and a device drive unit 290, as main constituent elements.

The CPU 210 controls various units of the electronic device 200 by executing programs stored in the memory 220 or an external storage medium.

The memory 220 is realized by various types of RAM, various types of ROM, and the like, and may be configured to be embedded in the electronic device 200, may be detachably connected to various interfaces of the electronic device 200, or may be a recording medium of another device accessible from the electronic device 200. The memory 220 stores programs executed by the CPU 210, data generated by execution of the programs by the CPU 210, data input via the operation unit 240, data received from a remote control, data received from the server 100 via a router 400 and the Internet, information necessary to use various services, such as the server address corresponding to the electronic device 200, and the like.

The display 230 outputs characters, images, and the like on the basis of signals from the CPU 210. Note that the display 230 may simply be an LED light or the like.

The operation unit 240 is realized by a button, a touch panel, or the like, receives commands from the user, and inputs the commands to the CPU 210. Note that the display 230 and the operation unit 240 may configure a touch panel 250.

The communication interface 260 is realized by an antenna configured to perform wireless communication, a connector configured to perform wired communication, and the like. The CPU 210 uses the communication interface 260 to exchange various types of data with the server 100, the other electronic devices 200, the communication terminal 300, and the like via the router 400, the Internet, and the like. For example, the CPU 210 transmits the environmental information to the server 100 via the communication interface 260, or receives the operational commands from the server 100.

The speaker 270 outputs voice messages and the like, on the basis of voice data from the CPU 210. The microphone 280 acquires the user's voice and the like and inputs the voice data to the CPU 210.

The device drive unit 290 controls each unit (such as a motor, a heater, a sensor, and an antenna) of the electronic device 200, on the basis of the signals from the CPU 210. For example, with respect to the microwave oven 200A, the unit may be an antenna or a rotary table for cooking, and with respect to the air conditioner 200B, the unit may be a compressor or a fan.

### Configuration of Communication Terminal 300

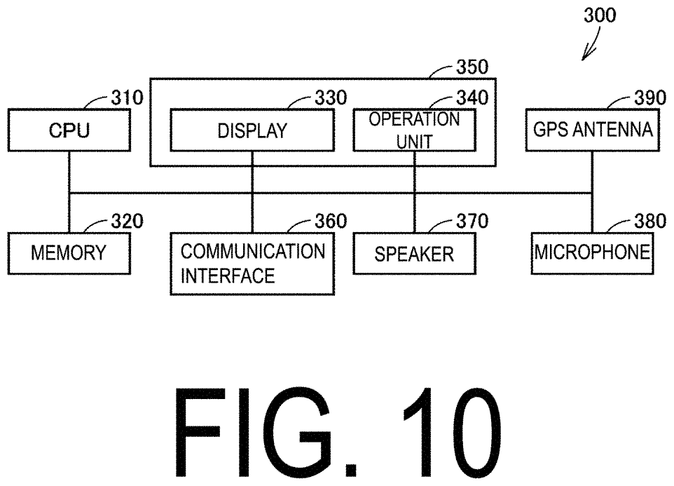

Next, an example of the configuration of the communication terminal 300 configuring the network system 1 will be described with reference to FIG. 10. The communication terminal 300 according to the present embodiment includes a CPU 310, a memory 320, a display 330, an operation unit 340, a communication interface 360, a speaker 370, a microphone 380, and a GPS antenna 390, as main constituent elements.

The CPU 310 controls each of units of the communication terminal 300 by executing programs stored in the memory 320.

The memory 320 is realized by various types of RAM, various types of ROM, and the like. The memory 320 stores application programs for various services and a program for a notification agent, data generated by execution of the programs by the CPU 310, data received from the server 100, data input via the operation unit 340, information for identifying a user of the communication terminal 300, and the like.

The display 330 displays images and text on the basis of data from the CPU 310. The operation unit 340 is configured by a pointing device, a switch, or the like, and inputs various commands from the user into the CPU 310. Note that the user terminal may include a touch panel 350 including the display 330 and the operation unit 340.

The communication interface 360 transmits and receives data to and from other devices, such as the server 100 and the electronic device 200, via the Internet, the carrier network, the router 400, and the like. For example, the CPU 310 exchanges various pieces of information, with the server 100, relating to the user, via the communication interface 360, in accordance with the program for the notification agent. The CPU 310 can receive various services by providing the various pieces of information to other application programs.

The speaker 370 outputs voice messages and the like on the basis of voice data from the CPU 310. The microphone 380 acquires the user's voice and the like and inputs the voice data to the CPU 310.

The GPS antenna 390 receives a radio wave signal from a satellite and transfers the signal to the CPU 310. The CPU 310 acquires the current position based on the GPS signal.

In the present embodiment, the CPU 310 acquires various pieces of information from the server 100 via the communication interface 360, in accordance with the program for the notification agent. Using the user's current location information, calendar information, weather forecast information, user preferences, and the like, the CPU 310 acquires various data from the server 100 via the communication interface 360 in accordance with an application program for a cooking appliance, and, via the touch panel 350, displays an operation screen for the cooking appliance, displays recipes for cooking using the cooking appliance, and the like. Besides this example, using the user's current location information, the calendar information, the weather forecast information, the user preferences and the like, the CPU 310 acquires image data and voice data via the communication interface 360 in accordance with the various application programs, and outputs the data from the display 330 and the speaker 370.

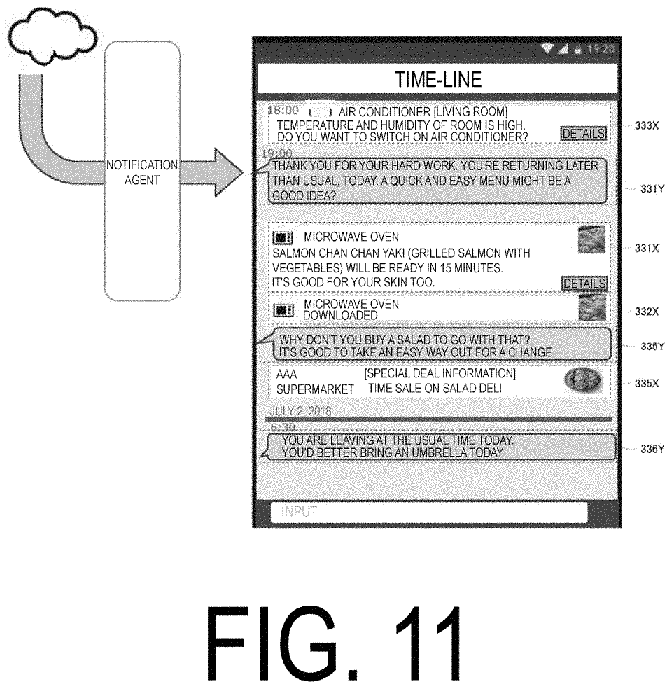

For example, as illustrated in FIG. 11, in accordance with the program for the notification agent, the CPU 310 displays, in a first display format on the display 330, input information transferred to the various application programs (such as 331Y, 335Y, 336Y, and the like). Then, the CPU 310 displays information displayed in accordance with the application program for the cooking appliance in a second display format corresponding to the application program on the display 330 (331X, 332X, and the like for example), displays information displayed in accordance with an application program for an air conditioner in a third display format corresponding to the application program on the display 330 (333X, and the like, for example), and displays information displayed in accordance with an application program for viewing videos and listening to music in a fourth display format corresponding to the application program on the display 330.

More specifically, in the present embodiment, the CPU 310 displays, in the first display format, the messages 331Y, 335Y, and 336Y indicating the input information transferred to various application programs and services in accordance with the program for the notification agent on the display 330. Then, in accordance with the application program for the cooking appliance, the CPU 310 displays the information 331X and 332X, which are output as a result of being triggered by the input information, in the second display format corresponding to the application program on the display 330. Further, the CPU 310 displays, in accordance with the application program for the air conditioner, the information 333X, which is output as a result of being triggered by the input information, in the third display format corresponding to the application program on the display 330. In addition, the CPU 310 displays, in accordance with the program for the notification agent, information 335X, which is output as a result of being triggered by the input information, in a fifth display format or a sixth display format corresponding to the service on the display 330.

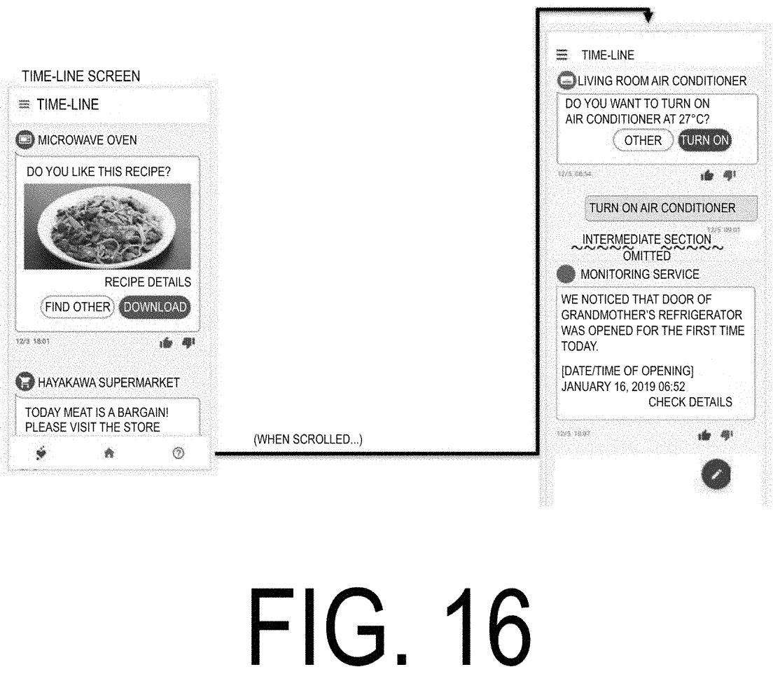

However, the CPU 310 may perform display such that messages are posted by each household electric appliance and each service, as illustrated in FIG. 16.

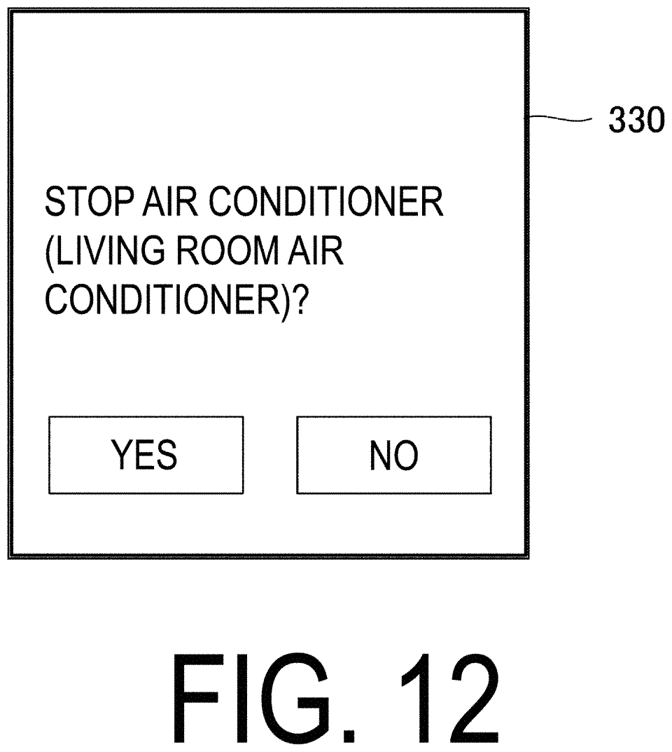

In addition, as illustrated in FIG. 2, in the present embodiment, the CPU 310 causes the touch panel 350 to display a screen for operating the electronic devices 200, on the basis of a user operation. Then, when an area of each of the electronic devices 200 is touched through the touch panel 350, the CPU 310 displays an individual normal operation screen for the electronic device 200 on the touch panel 350, and receives individual normal operation commands for the electronic device 200. In the present embodiment, as illustrated in FIG. 12, the CPU 310 is configured to obtain approval from the user as to whether the normal operation command may be executed. When the user approval is obtained, the CPU 310 transmits the normal operation command to the server 100 via the communication interface 360.

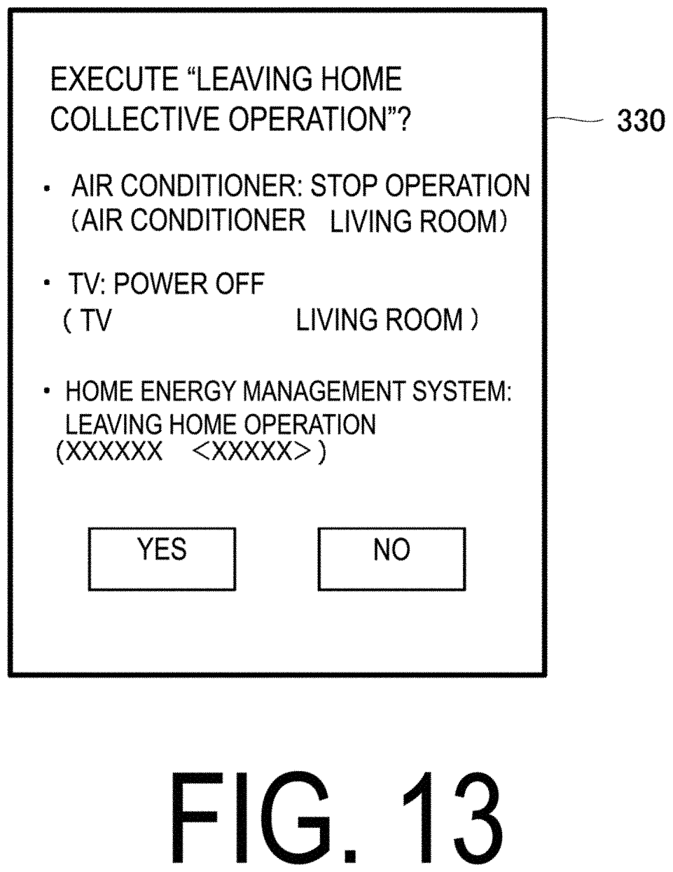

On the other hand, when collective operation buttons 337A, 337B, 337C, 337D, and 337E are pressed through the touch panel 350, the CPU 310 is configured to obtain approval from the user through the touch panel 350, as to whether a collective operation command may be executed for the plurality of electronic devices 200, as illustrated in FIG. 13. Note that the collective operation command for the plurality of electronic devices 200 may be acquired from the server 100 when the collective operation buttons 337A, 337B, 337C, 337D, and 337E are pressed, or the collective operation command may be stored in the communication terminal 300. When the user approval is obtained, the CPU 310 transmits one of the collective operation commands to the server 100 via the communication interface 360.

Note that the CPU 310 may accept the collective operation command for the plurality of electronic devices 200 via the microphone 380. In this case, the CPU 310 is preferably configured to obtain the approval of the user via the speaker 370 and the microphone 380 as to whether to execute the collective operation command for the plurality of electronic devices 200.

Note that the CPU 310 periodically transmits the current position to the server 100 via the GPS antenna 390. In this way, the server 100 determines whether the user is away from home, has returned home, will soon be home, or the like, and determines whether this matches a condition. Then, when the condition is matched, the server 100 is preferably configured to obtain approval from the user via the communication terminal 300 as to whether to execute the collective operation command for the plurality of electronic devices 200.

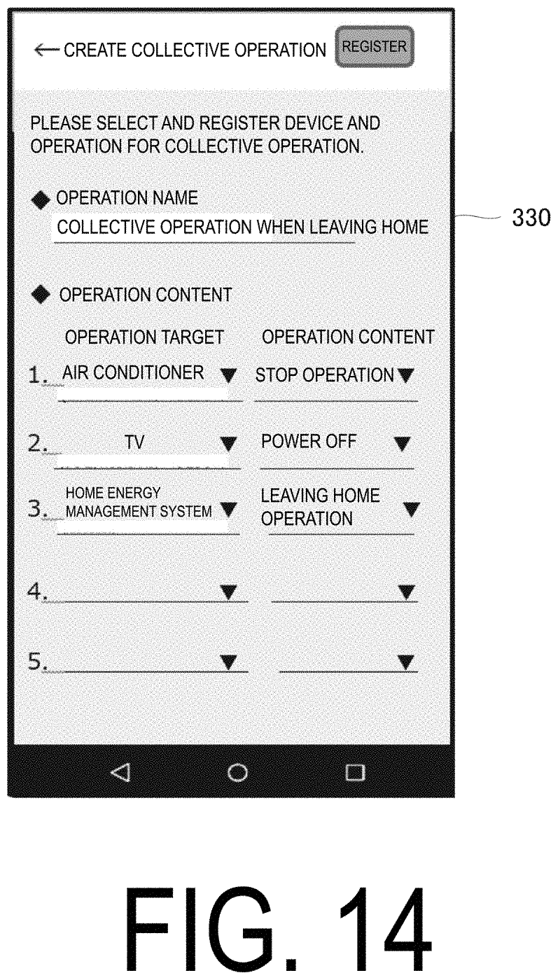

Then, in the present embodiment, as illustrated in FIG. 14, the CPU 310 accepts registration of the operation command for the plurality of electronic devices 200 for each type of the collective operation command through the operation unit 340. The CPU 310 transmits, to the server 100 via the communication interface 360, registration information of the operation commands for the plurality of electronic devices 200 for each type of the collective operation command. The CPU 110 of the server 100 receives the registration information via the communication interface 160, and registers the operation commands for the plurality of electronic devices 200 for each user ID or family ID in the collective operation command data 124.

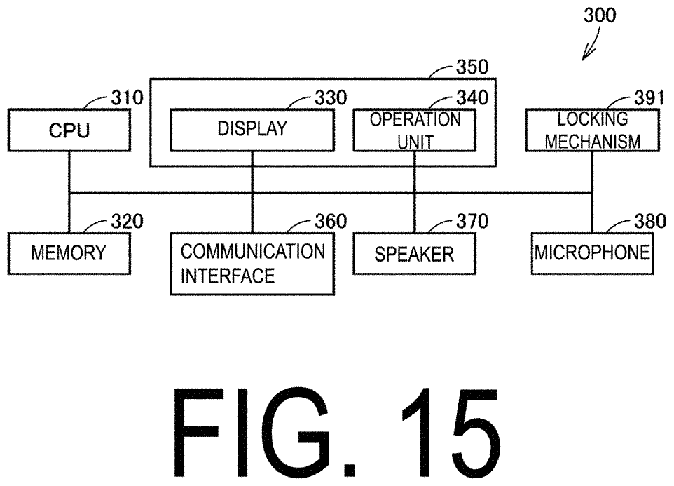

Note that, when the communication terminal 300 is a locking device that opens and closes the front door lock, as illustrated in FIG. 15, the communication terminal 300 includes a locking mechanism 391. The locking mechanism 391 transfers information to the CPU 310 that the front door has been locked or has been unlocked. The CPU 310 transmits data indicating that the front door has been locked and data indicating that the front door has been unlocked to the server 100 via the communication interface 360.

### Second Embodiment

Note that the input of the collective operation command is not limited to being made on the communication terminal 300 by the user. For example, the user may input the collective operation command into a device separate from the communication terminal 300, or may propose or register commands executed on the plurality of electronic devices 200 within a prescribed time as the collective operation command.

Alternatively, a cloud service configured by the server 100 and the like may acquire an operational history for the electronic device 200 and a behavioral history of the user, and may learn the user's habits through artificial intelligence (AI). For example, the server 100 learns a habit that is “when the user returns home, the user causes the air conditioner to automatic operation and powers ON the TV.” In this way, by detecting that the user has “returned home,” the server 100 can automatically put ON the air conditioner 200B and can also turn on the TV 200C.

Note that each time the server 100 detects that the user has “returned home,” the CPU 310 of the communication terminal 300 may confirm “Do you want to turn on the air conditioner and the TV?” with the user, in accordance with the application program. The user may then press a “Yes please” button, or may say “Yes please” to the microphone, and thus may collectively transmit the operation commands to the electronic devices 200.

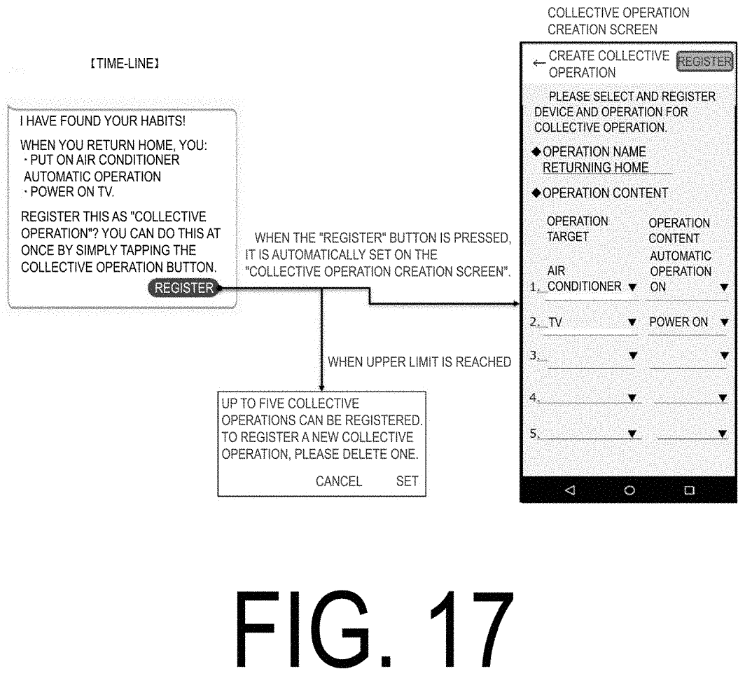

More preferably, the server 100 uses artificial intelligence (AI) to discover the habit that is “when the user returns home, the user causes the air conditioner to automatic operation and powers ON the TV.” Based on data from the server 100, the communication terminal 300 proposes registration of the collective operation command suited to the habits of the user, as illustrated in FIG. 17. For example, the communication terminal 300 outputs a message “How would you like to register a collective operation command for the air conditioner and the TV?” Then, when the user presses a “Register” button or says “Yes please” to the microphone, the server 100 “registers” the collective operation command. Once the collective operation command is registered, from now on, the user can press the “collective operation” button of the communication terminal 300 to operate the plurality of electronic devices 200 when the user returns home (just before the user returns home).

### Third Embodiment

In the embodiment described above, the operation command is transmitted to the plurality of electronic devices 200 when the condition of the collective operation is satisfied. However, sometimes some of the plurality of electronic devices 200 are already executing the command for the collective operation.

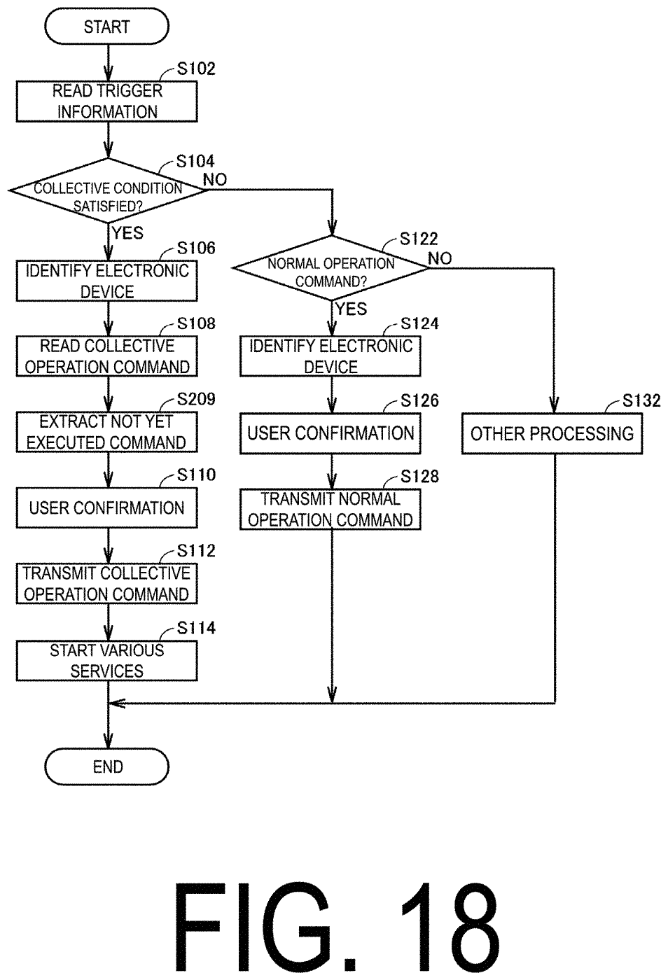

Thus, in the present embodiment, as illustrated in FIG. 18, the CPU 110 reads the operation command for each of the identified electronic devices 200 at step S108, and then refers to the device information data 122 to identify the electronic device 200 that has not yet executed the operation command, or the operation command that has not yet been executed (step S209).

Then, the CPU 110 transmits, via the communication interface 160, information to the user's communication terminal 300 to confirm whether the collective operation may be performed with respect to the electronic device 200 that has not yet executed the operation command concerned (step S110).

Once the user's confirmation has been obtained, the CPU 110 transmits, via the communication interface 160, the operation command suitable for the current situation to the electronic device 200 that has not yet executed the operation command (step S112).

### Fourth Embodiment

In addition to the configurations described above, conditions relating to the time zone, conditions relating to the day of the week, and conditions relating to the season may be added as conditions for determining prescribed timings, such as “a prescribed operation reception time,” the “leaving home time,” the “returning home time,” the “wake-up time,” and the “bedtime.” For example, in spring, the server 100 starts operation of the air conditioner or the air cleaner in a “pollen mode,” and in summer, starts operation of the air conditioner and the air cleaner to operate in a “rainy season mode.” Alternatively, when the user returns home during daytime in the summer, the lighting is turned on at a brightness OFF, when the user returns home during daytime in the winter, the lighting is turned on at a low brightness, and when the user returns home at night, the lighting is turned on at a strong brightness.

### Fifth Embodiment

Some or all of the roles of each of the devices of the network system 1 in the above-described embodiments may be performed by other devices. For example, another device may perform part or all of the roles of each of the server 100, the electronic device 200, and the communication terminal 300, or some or all of the roles of each of the devices may be assigned to a plurality of devices.

### Supplement

In the above-described embodiments, a network system is provided that includes a communication terminal including a microphone, a plurality of electronic devices, and a server. The server is configured to transmit a prescribed operation command collectively to the plurality of electronic devices linked to the communication terminal, based on a prescribed voice message from the communication terminal.

In the above-described embodiments, a network system is provided that includes a communication terminal having a position information acquisition function, a plurality of electronic devices, and a server. The server is configured to transmit a prescribed operation command collectively to the plurality of electronic devices linked to the communication terminal, based on position information from the communication terminal.

In the above-described embodiments, a network system is provided that includes a communication terminal including an operation unit, a plurality of electronic devices, and a server. The server is configured to transmit a prescribed operation command collectively to the plurality of electronic devices linked to the communication terminal, when the communication terminal receives a prescribed operation.

In the above-described embodiments, a network system is provided that includes a communication terminal including a locking/unlocking mechanism configured to lock and unlock a door, a plurality of electronic devices, and a server. The server is configured to transmit a prescribed operating command collectively to the plurality of electronic devices linked to the locking/unlocking mechanism, when the server receives data from the communication terminal indicating that the door is one of locked and unlocked.

Preferably, when the server transmits a prescribed operation command collectively to the plurality of electronic devices, the server prompts a user, through the communication terminal, to approve the operation command.

Preferably, the server is configured to stores a plurality of operation commands for each of the plurality of electronic devices, and when the server collectively transmits a prescribed operation command to the plurality of electronic devices, the server extracts, from among the plurality of electronic devices, the electronic device executing a command different from a plurality of commands, and prompts approval of the prescribed operation command with respect to the extracted electronic device.

Preferably, when the server transmits the prescribed operation command collectively to the plurality of electronic devices, the server also initiates a prescribed service.

Preferably, the server is configured to use learning through artificial intelligence (AI) and acquire a habit of a user of the communication terminal, and propose, to the user, a collective prescribed operation command suited to the habit.

The embodiments disclosed here are to be understood as being in all ways exemplary and in no ways limiting. The scope of the disclosure is defined not by the foregoing descriptions but by the appended claims, and is intended to include all changes equivalent in meaning and scope to the claims.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A network system comprising:
a communication terminal including a microphone;
a plurality of electronic devices; and
a server,
wherein the server is configured to transmit a prescribed operation command collectively to the plurality of electronic devices linked to the communication terminal, based on a prescribed voice message from the communication terminal.

2. A network system comprising:
a communication terminal having a position information acquisition function;
a plurality of electronic devices; and
a server,
wherein the server is configured to transmit a prescribed operation command collectively to the plurality of electronic devices linked to the communication terminal, based on position information from the communication terminal.

3. A network system comprising:
a communication terminal including an operation unit;
a plurality of electronic devices; and
a server,
wherein the server is configured to transmit a prescribed operation command collectively to the plurality of electronic devices linked to the communication terminal, when the communication terminal receives a prescribed operation.

4. A network system comprising:
a communication terminal including a locking/unlocking mechanism configured to lock and unlock a door;
a plurality of electronic devices; and
a server,
wherein the server is configured to transmit a prescribed operation command collectively to the plurality of electronic devices linked to the locking/unlocking mechanism, when the server receives data from the communication terminal indicating that the door is one of locked and unlocked.

5. The network system according to claim 1,
wherein
when the server transmits a prescribed operation command collectively to the plurality of electronic devices, the server prompts a user, through the communication terminal, to approve the operation command.

6. The network system according to claim 1,
wherein
the server is configured to store a plurality of operation commands for each of the plurality of electronic devices, and
when the server collectively transmits a prescribed operation command to the plurality of electronic devices, the server extracts, from among the plurality of electronic devices, the electronic device executing a command different from a plurality of commands, and prompts approval of the prescribed operation command with respect to the extracted electronic device.

7. The network system according to claim 1,
wherein
when the server transmits the prescribed operation command collectively to the plurality of electronic devices, the server also initiates a prescribed service.

8. The network system according to claim 1,
wherein
the server is configured to use learning through artificial intelligence (AI) and acquire a habit of a user of the communication terminal, and propose, to the user, a collective prescribed operation command suited to the habit.
